(19) United States
(12) Patent Application Publication
(10) Pub. No.: US 2005/0041673 A1
(43) Pub. Date: Feb. 24, 2005

(54) Method of managing wireless network resources to gateway devices

(76) Inventors: Frances Jiang, Whippany, NJ (US); Yang Yang, Parsippany, NJ (US)

Correspondence Address: CARLSON, GASKEY & OLDS, P.C., 400 WEST MAPLE ROAD, SUITE 350, BIRMINGHAM, MI, 48009, US

(21) Appl. No.: 10/644,346

(22) Filed: Aug. 20, 2003

(51) Int. Cl. H04L 12/56

(52) U.S. Cl. 370/401

(57) ABSTRACT

A resource allocation method equalizes distribution of network resources among gateway users connected to at least one gateway access terminal and non-gateway users. Gateway access terminals having data backlogs exceeding a predetermined backlog threshold are assigned higher priorities to increase their transmission rate and relieve the backlog. Alternatively, priority is assigned based on the relative data backlogs of all of the gateway access terminals in the network. This ensures that gateway users are allocated resources fairly and in a comparable manner to non-gateway users, maximizing system throughput.

### BACKGROUND OF THE INVENTION

1. Field of the Invention

The present invention relates to wireless communication networks.

2. Description of the Related Art

Wireless communication systems rely on data sharing arrangements to allow multiple users to share common resources. As shown in FIG. 1, the wireless system 100 has a plurality of base stations 102, each base station 102 acting as a communications hub for a particular coverage area, or sector 104.

Active users 106 within a given sector 104 share common resources. Each base station 102 may employ a resource assignment algorithm to ensure that the resources are fairly distributed among the users 106. Wireless systems often use a timeslot-based resource sharing channel in a forward link of the system to allocate resources. More particularly, a scheduler algorithm in the base station 102 allocates timeslot resources to all gateway access terminals and all users in the sector 104. For wireless users 106, each user 106 is viewed by the base station 102 as a single device and is therefore allocated one timeslot by the base station 102.

To increase usage of wireless data networks, there have been proposals to connect wireline and wireless data networks together (e.g., a WiFi system). In such a system, a wireline LAN can be connected to a gateway access terminal device that acts as a gateway serving multiple wireline users 110. This allows the wireline users 110 to access data in a mobile environment. To the base station 102, the gateway access terminal 108 appears as a single device and is therefore allocated one timeslot. However, because multiple users 110 can be connected to the gateway 108, gateway users 110 must share resources normally allocated to a single non-gateway user 106. As a result, individual gateway users 110 will receive fewer resources than non-gateway users 106 in the same network 100, increasing the likelihood of service degradation for the gateway users 110.

There is a desire for a method that allocates resources among gateway users and non-gateway users more fairly.

### SUMMARY OF THE INVENTION

The present invention is directed to a method of equalizing distribution of network resources among gateway users and non-gateway users in a wireless communication network system. In one embodiment, the network identifies gateway access terminals and monitors the data backlog in each of the gateway access terminals. Gateway access terminals having data backlogs exceeding a predetermined backlog threshold are assigned higher priorities to increase their transmission rate and relieve the backlog. This ensures that the gateway users connected to the network via gateway access terminals are allocated resources fairly and in a comparable manner to non-gateway users.

By allocating more resources to gateway access terminals having data backlogs, the invention is able to minimize or eliminate the data backlogs quickly and maintain high throughput for the gateway users even though they share resources normally allocated to a single non-gateway user. As a result, the invention maximizes system throughput and equalizes performance between gateway users and non-gateway users.

### BRIEF DESCRIPTION OF THE DRAWINGS

FIG. 1 is a representative diagram of a wireless communication system environment in which one embodiment of the invention operates;

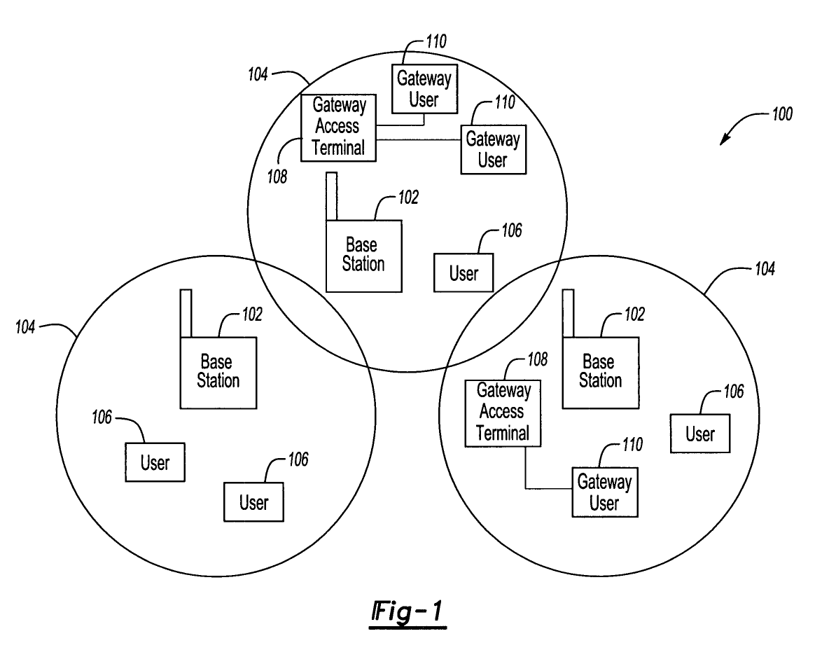

FIG. 2 is a flow diagram illustrating a method according to one embodiment of the invention;

FIG. 3 is a flow diagram illustrating a portion of a method according to another embodiment of the invention.

### DETAILED DESCRIPTION

Generally, the invention improves the quality of service given to gateway users 110 by allowing the base station 102 to identify the gateway access terminals 108 in the network 100 and then favor the gateway access terminals 108, if needed, when distributing resources to compensate for the timeslot sharing of the gateway users 110. By favoring the gateway access terminals 108 in resource distribution, the service quality experienced by the gateway users 110 and the non-gateway users 106 can be made comparable even though multiple gateway users 110 may share timeslot resources normally allocated to a single non-gateway user 106.

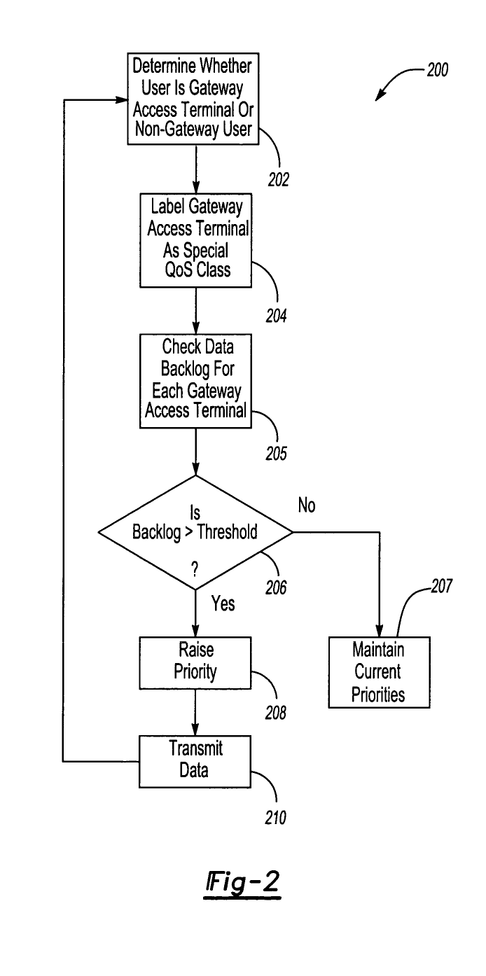

FIG. 2 is a flow diagram illustrating a method 200 according to one embodiment of the invention. When the base station 102 receives a signal, the base station 102 first determines whether the signal is from a non-gateway user 106 or a gateway access terminal 108 (e.g., a WiFi user) (block 202). This can be conducted by, for example, assigning different identification codes to the non-gateway users 106 and the gateway access terminals 108 and then storing those identification codes in a database accessible by the base station 102. The identification code itself can be, for example, an electronic serial number (ESN) or an international mobile subscriber ID (IMSI) associated with the user 110 or access terminal 108. The database may be disposed in any location accessible by the base station 102, such as a central storage location (not shown) in the network 100 or in a controller of each base station 102.

When the base station 102 receives an identification code via a signal, the base station 102 looks up the identification code in the database to determine whether the signal was sent from a non-gateway user 106 or a gateway user 110 through the gateway access terminal 108. Other identification methods are also possible without departing from the scope of the invention.

Once the base station 102 has identified the gateway access terminal 108, the gateway access terminals 108 are labelled as a special QoS class (block 204). In one embodiment, the database containing identification codes assigned to gateway access terminals 108 also links a QoS class to each identification code.

The method then checks whether the service quality experienced by the gateway access terminal 108 is already sufficient. For example, if the gateway user 110 is the only user operating through a given gateway device 108, then the gateway user 110 has an entire timeslot to itself; in this case, the base station 102 does not need to modify the resource allocation of the gateway access terminal 108 associated with that gateway user 110 because it has the same resources as non-gateway users 106 and is therefore not at any disadvantage. Note that current wireless standards may not allow detection of the actual number of gateway users 110 accessing the network 100 through one gateway device 108 because doing this would require a special, currently unavailable interface from the gateway device 108 to the network 100. However, the invention is still applicable even if the wireless standards change to provide this information.

To work within the current wireless standards, the inventive method 200 makes an educated guess on the number of gateway users 110 sharing a timeslot by monitoring a buffer size of each gateway access terminal 108 (block 205). The method 200 then determines whether to increase the data transmission rate of a given gateway access terminal 108 based on a determination of whether the data backlog size indicates that the gateway user requires more resources. Gateway users 110 that are sharing a single gateway access terminal 108, and therefore a single timeslot, with other gateway users 110 will tend to cause the gateway access terminal 108 to have a larger data backlog, and therefore a larger buffer size, than the non-gateway users 106 or gateway access terminals 108 connecting a single user 110 to the network 110. This is because gateway users 110 sharing a single timeslot have fewer data transmission opportunities than users 106, 110 that do not need to share the timeslot.

More particularly, the base station 102 checks the amount of backlog experienced by each gateway access terminal 108 and selects one or more gateway access terminals 108 whose priority is to be raised to reduce the backlog. The backlog for a given gateway access terminal is the aggregate backlog of the gateway users 110 accessing that terminal 108. Gateway access terminals 108 whose data backlog sizes are below the threshold have their priorities maintained at their current levels (block 207). Generally, the base station 102 checks whether the backlog for a given gateway access terminal 108 exceeds a threshold (block 206). If any of the gateway access terminals 108 have backlogs higher than the threshold, the base station 102 raises the priority of those gateway access terminals 108 (block 208). The base station 102 may choose to raise the priority of only the gateway access terminal 108 having the highest backlog or, alternatively, raise the priority of all of the gateway access terminals 108 whose backlogs exceed the threshold.

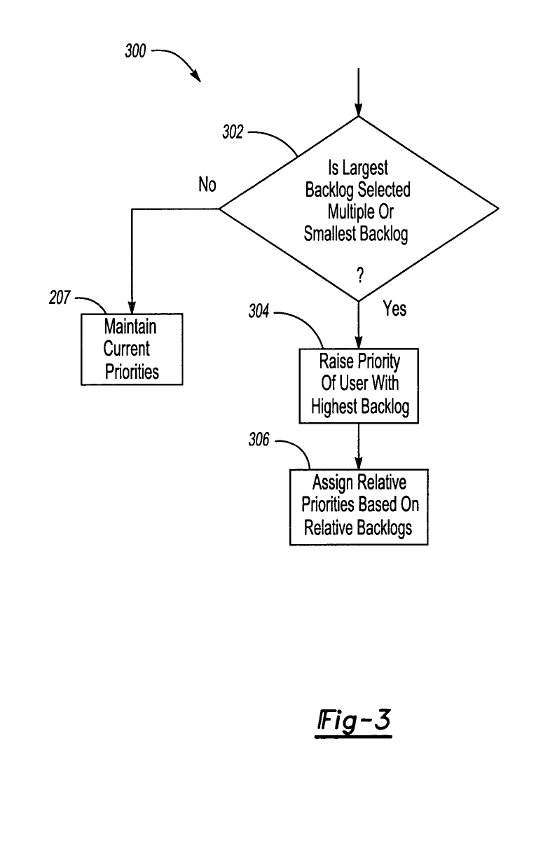

FIG. 3 illustrates an alternative method 300 of selecting which gateway access terminals 108 will receive higher priority. These steps may be used in place of the threshold comparison step (block 206) and the priority raising step (block 208) in FIG. 2. In this embodiment, the base station 102 compares the largest backlog size with the smallest backlog size (block 302) and raises the transmission priority for the gateway access terminals 108 with the largest data backlog. In one embodiment, the priority of the gateway access terminals 108 is raised if its data backlog is a selected multiple (e.g., three or four times) of the smallest data backlog (block 304).

Regardless of the way the base station 102 identifies gateway access terminals 108 having a high data backlog, the scheduling algorithm used by the base station 102 may allocate resources among both the gateway access terminals 108 and non-gateway users 106. The scheduling algorithm access_term_selection(n), which determines the order in which the access terminals 108 are to be serviced, can be expressed generally as:
access_term_selection(n)=arg maxᵢ{Priorityᵢ(n)} (Equation 1)
where n is a given timeslot, i identifies a particular gateway access terminal, and arg maxᵢ corresponds to the access terminal i having the largest value for the mathematical argument of the priority value Priorityᵢ(n) function at the given timeslot n. The scheduler algorithm access_term_selection(n) schedules service by first calculating the priority for each terminal 108 (i.e., arg (Priorityᵢ(n)) and then selecting the terminal having the highest priority value for resource reallocation (i.e., arg maxᵢ (Priorityᵢ(n)). In other words, gateway access terminals 108 having higher Priorityᵢ values will be serviced before gateway access terminals 108 having lower priority values.

As explained above, the priority of each gateway access terminal 108 will be dictated at least in part by the amount of backlog in the terminal 108. In one embodiment, the priority for each gateway access terminal i in timeslot n is evaluated as a function f of the QoS requirements QoSᵢ for that user, the performance Perfᵢ(n) realized by the user i, the user's RF condition DRCᵢ, and the amount of backlog Backlogᵢ(n) as follows:
Priorityᵢ(n)=ƒ{QoSᵢ,Perfᵢ(n), DRCᵢ(n),Backlogᵢ(n)} (Equation 2)
wherein QoSᵢ is the quality of service requirements applied when servicing the gateway access terminal i, Perfᵢ(n) is the actual network performance experienced by the gateway access terminal i, DRCᵢ(n) is the RF conditions under which network service to the gateway access terminal takes place, and Backlogᵢ(n) is the data backlog for the gateway access terminal i at the timeslot n noted above. The priority function itself can be determined in any way, using any desired function f of the parameters noted above as well as other parameters that may affect quality of service to the terminals and the users. As can be seen from Equation 2, the priority of a given gateway access terminal 108 can be influenced by factors in addition to the amount of data backlog. The specific function used to weight the various parameters for determining the priority of a given access terminal 108 can be determined and selected in any known manner. The specific details of the function used for the priority calculation can be ascertained and designed by one of ordinary skill in the art and are not critical to the invention.

The realized system performance is updated on a per timeslot basis as follows (block 302):
Perfᵢ(n+1)=g{QoSᵢ, Perfᵢ(n), Actionᵢ(n) } (Equation 3)
where Perfᵢ(n+1) is the actual network performance experienced in a subsequent timeslot (n+1), QoSᵢ is the quality of service requirements applied when servicing the gateway access terminal i as noted above, Perfᵢ(n) is the actual network performance experienced by the gateway access terminal i at timeslot n, and Actionᵢ(n) is the actual action (e.g., gateway access terminal selection and transmission rate based on the priority) conducted by the scheduler in slot n with respect to gateway access terminal i.

As can be seen in Equation 3, the realized performance Perfᵢ(n+1) is updated for the subsequent time slot (n+1) using an arbitrary desired function g of the QoS requirements QoSᵢ, the previous performance of the user Perfᵢ(n), and the action taken by the scheduler in the previous slot n. The information that is included in Actionᵢ(n) can vary depending on which performance variables are included in Perfᵢ. For example, if the base station 102 decides to service the highest priority gateway access terminal with a very high data rate in a given timeslot n, that service will be considered an action for that gateway access terminal i in that timeslot n (i.e., Actionᵢ(n)) and will impact that gateway access terminal's performance Perfᵢ(n+1) in the next timeslot, potentially changing the calculated Priority value for that gateway access terminal user in the next timeslot n+1 as well.

As noted above, the inventive method assigns the highest priority value to the gateway access terminal 108 with the largest data backlog (block 208) if the amount of the backlog is determined to be large enough to warrant a priority adjustment. This allows the gateway access terminal 108 with the largest data backlog to be allocated a larger share of timeslot resources than other gateway access terminal 108. Other gateway access terminals 108 with data backlogs may also have their priority values adjusted based on the amount of backlog they have; in one embodiment, the relative priorities for each gateway access terminal 108 having a backlog are assigned based on the relative sizes of their backlogs (block 306), as shown in FIG. 3.

Thus, rather than having to share resources equally with the non-gateway users 106, the gateway access terminal 108 with the largest data backlog is given higher priority, and therefore more timeslot resources, to increase its data transmission rate. Note that if a gateway access terminal 108 has a particularly large data backlog, the timeslot allocation for that gateway access terminal 108 may be large enough to warrant dropping the transmission rate of other gateway access terminal devices 108 to a minimum level (e.g., a minimum QoS level) for a limited time period. However, the method may also compare the resources allocated to each gateway access terminal 108 with a predetermined hogger threshold at each timeslot to ensure that no gateway access terminal 108 becomes a resource hogger.

After the gateway access terminals 108 have transmitted their respective data based on the priorities and QoS assigned to them, the process repeats itself to reallocate resources among the gateway access terminals. Because the method assigns a larger share of timeslot resources to the access terminal having the largest data backlog, repeated iterations of the inventive method will raise the priorities for different gateway access terminals. More particularly, once the gateway access terminal 108 having the highest priority transmits its data, the priority for that gateway access terminal 108 will likely be lower in the next timeslot. This is because the high priority transmission will reduce, or even eliminate, the backlog for that gateway access terminal 108 to a level below other gateway access terminals 108 and/or below the backlog threshold. This ensures that the fixed resources for the gateway access terminals 108 are fairly distributed in the system 100 so that, if needed, the gateway access terminals 108 receive additional resources to relieve any data backlog. This keeps the throughput of the gateway access terminals 108, and consequently the gateway users 110 connected to those terminals 108, comparable to the throughput of non-gateway users 106.

By distinguishing between gateway access terminals and non-gateway users, the invention is able to monitor and control the service quality given to the gateway access terminals and, if needed, vary the scheduling priority of the gateway access terminals so that the service quality of the gateway users is comparable the service quality of the non-gateway users even though multiple gateway users often share one timeslot through the access terminals.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, this method, system and portions thereof and of the described method and system may be implemented in different locations, such as network elements, the wireless unit, the base station, a base station controller, a mobile switching center and/or radar system. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

1. A resource allocation method for a communication network having at least one gateway user connected to the network via at least one gateway access terminal and at least one non-gateway user, comprising:
identifying said at least one gateway access terminal;
obtaining a data backlog size of said at least one gateway access terminal; and
selectively raising the priority of at least one gateway access terminal based on the data backlog size.

2. The resource allocation method of claim 1, wherein the raising step is conducted if the data backlog size of said at least one gateway access terminal is above a predetermined threshold.

3. The resource allocation method of claim 1, wherein said at least one gateway access terminal comprises a plurality of gateway access terminals, and wherein the raising step comprises raising the priority of the gateway access terminal having the largest data backlog size.

4. The resource allocation method of claim 3, further comprising:
comparing the largest data backlog size with a smallest data backlog size among said plurality of gateway access terminals;
raising the priority of the gateway access terminal having the largest data backlog size if the largest data backlog size is at least a predetermined multiple of the smallest data backlog size; and
maintaining the priority of the gateway access terminal if the largest data backlog size is less than the predetermined multiple of the smallest data backlog size.

5. The resource allocation method of claim 3, wherein the raising step comprises:
comparing data backlog sizes for at least two of said plurality of gateway access terminals; and
assigning relative priorities for said at least two gateway access terminals based on the relative data backlog sizes of said at least two gateway access terminals.

6. The resource allocation method of claim 3, further comprising:
updating the data backlog size after at least one of said plurality of gateway access terminals transmits data; and
repeating the identifying, obtaining, and selectively raising steps for said plurality of gateway access terminals.

7. The resource allocation method of claim 1, further comprising maintaining the priority of one gateway access terminal if only one gateway user is connected to the gateway access terminal.

8. The resource allocation method of claim 1, further comprising labelling the gateway access terminals as a special quality of service (QoS) class.

9. The resource allocation method of claim 1, further comprising:
comparing resource usage of at least one gateway access terminal with a hogger threshold; and
adjusting the priority of said at least one gateway access terminal if the resource usage exceeds the hogger threshold.
